(19) United States
(12) Patent Application Publication
(10) Pub. No.: US 2019/0190323 A1
(43) Pub. Date: Jun. 20, 2019

(54) APPARATUS HAVING A SECONDARY COIL FOR INDUCTIVE CHARGE TRANSFER

(71) Applicant: Dr. Ing. h.c. F. Porsche Aktiengesellschaft, Stuttgart (DE)

(72) Inventors: Dirk Herke, Kirchheim unter Teck (DE); Anja Heinzelmann, Stuttgart (DE)

(21) Appl. No.: 16/212,711

(22) Filed: Dec. 7, 2018

(30) Foreign Application Priority Data
Dec. 18, 2017 (DE) 10 2017 130 280.8

(51) Int. Cl. H02J 50/90; H02J 50/10; H02J 7/02; H01F 38/14

(52) U.S. Cl. CPC H02J 50/90; H02J 50/10; B60Y 2200/91; H01F 38/14; H02J 7/025

(57) ABSTRACT

An apparatus for installation in a vehicle for the inductive electrical charging or discharging of the vehicle by a primary coil includes an underbody panel and a secondary coil. The secondary coil is electrically connected to a power unit of the vehicle by a reversibly connectable electrical connection.

### CROSS REFERENCE TO RELATED APPLICATIONS

This application claims benefit to German Patent Application No. DE 10 2017 130 280.8, filed Dec. 18, 2017, the entire disclosure of which is hereby incorporated by reference herein.

### FIELD

The present invention relates to an apparatus for installation in a vehicle, having a secondary coil, for an inductive electrical charge transfer between a primary coil and the secondary coil.

### BACKGROUND

In the context of environmental protection, increasingly more vehicle owners are relying on electric vehicles or plug-in hybrid vehicles. The vehicles are mostly charged at a charging station with the aid of a plug connection between the charging station and the vehicle. However, this is inconvenient. On the one hand, the plugging means an additional working step for the vehicle driver. On the other hand, the multiplicity of various plug systems involves having to carry a likewise great multiplicity of plug adapters in the vehicle.

Furthermore, devices that are constantly moved, such as the feed line from the charging station to the vehicle or the plug of the charging station, are subjected to wear and the risk of damage.

The inductive electrical charge transfer to vehicles is known from the prior art. The document WO 2014/206661 discloses an inductive charging device for charging an electric vehicle, in which energy is transmitted to a secondary coil from a primary coil. The document DE 10 2013 214 311 discloses a receiver coil for the inductive electrical charging of an electric vehicle, which receiver coil is integrated in a transmission oil sump. The document DE 10 2011 108 544 A1 discloses secondary coils, which are mounted on the underbody of a vehicle.

### SUMMARY

In an embodiment, the present invention provides an apparatus for installation in a vehicle for the inductive electrical charging or discharging of the vehicle by a primary coil. The apparatus includes an underbody panel and a secondary coil. The secondary coil is electrically connected to a power unit of the vehicle by a reversibly connectable electrical connection.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic sectional image of an apparatus according to an embodiment of the invention;

FIG. 2 shows a schematic sectional image of an apparatus according to a further embodiment of the invention; and

FIG. 3 shows a schematic sectional image of an apparatus according to an even further embodiment of the invention.

### DETAILED DESCRIPTION

A disadvantage of the prior art is that either coil housings for accommodating the secondary coils have to be built in a complex manner or that the secondary coils cannot be exchanged easily but instead are usually connected in a fixed manner to the vehicle, in particular to a power unit of the vehicle.

Embodiments of the present invention provide an apparatus and a method that exhibit the saving of a coil housing, the saving of installation space in the vehicle, the possible integration in a component of the vehicle and an easy exchangeability compared to the prior art.

Embodiments of the invention provide apparatuses for installation in a vehicle for the inductive electrical charging or discharging of the vehicle by a primary coil, wherein the apparatuses have an underbody panel, wherein the apparatuses have a secondary coil, characterized in that the secondary coil is electrically connected to a power unit of the vehicle by means of a reversibly connectable electrical connection. In this way, there is provision for apparatuses that are suitable for the inductive electrical energy transmission from the primary coil to the secondary coil. The primary coil is placed outside of the vehicle and connected to an electricity grid. In the energy transmission process, said primary coil constitutes a transmitter. The secondary coil is electrically connected to the vehicle and in the energy transmission process constitutes the receiver. The primary coil and the secondary coil are preferably designed as circular coils or as coils in a double-D shape. The secondary coil is reversibly contact-connected to a power electronics system, for example an AC/DC converter. This can be realized, for example, by means of a plug connection, by means of a screwed connection or by means of a magnetic contact. The connection is releasable so that the apparatus can be easily attached to the vehicle or detached from the vehicle. The apparatuses can additionally have actuation elements for actuating a charging apparatus outside of the vehicle or else identification elements for identifying a vehicle during a charging process. The underbody panel of the apparatuses can be a part of the underbody panel of the vehicle. In accordance with embodiments of the invention, the apparatuses are preferably provided for installation on the underside of a vehicle.

In accordance with a preferred embodiment of the invention, there is provision for at least some of the apparatus to have a ferrite layer on a top side of the underbody panel, which top side faces away from the ground in a state in which the apparatus is installed in the vehicle. This advantageously causes the secondary coil to be shielded from interfering influences from the direction of the vehicle. The ferrite layer can be screwed, adhesively bonded or plugged to the underbody panel. However, it is also conceivable for the ferrite layer to be secured not to the underbody panel but directly to the underside of the vehicle. The latter would facilitate a more simple exchange of parts of the apparatus.

In accordance with a further preferred embodiment of the invention, there is provision for the secondary coil to be mounted on the upper side of the underbody panel. This advantageously makes it possible to protect the secondary coil against mechanical damage, such as by stone chipping, for example, owing to the underbody panel. The underbody panel is preferably produced from plastic. This makes it possible to transfer energy from the primary coil to the secondary coil while reducing losses due to damping or leakage fluxes.

In a further preferred embodiment of the present invention, there is provision for the secondary coil to be mounted in the underbody panel of the vehicle. The underbody panel is preferably produced from a plastic, the dielectric properties of which do not influence the transmission of energy from the primary coil to the secondary coil. Mounting the secondary coil in the underbody panel makes it possible to provide good protection against mechanical damage to the secondary coil. Furthermore, the distance from the primary coil to the secondary coil is thus reduced, which in turn causes an increase in efficiency in the energy transmission.

In accordance with a further preferred embodiment of the invention, there is provision for at least some of the underbody panel to be produced from a ferrite/plastic mixture. This makes it possible to shield against electromagnetic fields, which are suited to interfering with the transfer of energy. The embodiment as a ferrite/plastic mixture nevertheless permits a simple formation of the underbody panel in the production process as well as a high degree of robustness. It is conceivable, for example, to mount the secondary coil inside the underbody panel and to manufacture from a ferrite/plastic mixture only the regions of the underbody panel that in the energy transmission are not present in a volume through which the substantial part of the field lines between the primary coil and the secondary coil runs. It would thus be possible to shield the secondary coil in a directionally targeted manner. At the same time, the formation of the ferrite determines the behavior of the magnetic field. This produces the advantage that, in addition to the shielding due to the ferrite, the shaping and orientation of the magnetic field can be determined.

In a further preferred embodiment of the present invention, there is provision for the secondary coil to be mounted on the underbody panel on a bottom side of the underbody panel, which bottom side faces toward the ground in a state in which the apparatus is installed in the vehicle. This would make it possible to minimize the distance between the secondary coil and the primary coil. Furthermore, this makes it possible to transfer energy between the primary coil and the secondary coil without materials between the two coils, which materials are suited to noticeably damping the electromagnetic field. It is conceivable that at least some of the underbody panel is produced from a ferrite/plastic mixture. It is also conceivable that the secondary coil is coated with a protective layer, which protects said secondary coil against mechanical damage, such as by stone chipping, for example, or against chemical damage, such as by corrosion, for example.

In accordance with a further preferred embodiment of the invention, there is provision for the underbody panel together with the secondary coil to be able to be reversibly screwed off, unclipped, unplugged from the vehicle and/or for the secondary coil to be able to be reversibly screwed off, unclipped, unplugged from the vehicle and the underbody panel. This makes it possible to easily exchange the secondary coil if it should be damaged. It is conceivable that the electrical connection between the secondary coil and the power unit of the vehicle is embodied as clips for clipping or as a screw connection for screwing the underbody panel to the vehicle. It is thus advantageously possible to mount and disassemble the underbody panel together with the secondary coil and in the process in the same working step to produce the electrical connection between the secondary coil and the power electronics system of the vehicle.

In a further preferred embodiment of the present invention, there is provision for the secondary coil to be adhesively bonded to the underbody panel or pressed onto the underbody panel. This makes a simple manufacturing process of the apparatus possible, in which complex manufacturing steps such as screwing or welding are not necessary. Furthermore, it is thus possible to precisely adapt the shape of the secondary coil to the respective shape of the underbody panel. It would also be conceivable, for example, to press spacers between the underbody panel and the secondary coil. The shaping along the main plane of extent of the secondary coil could thus be selected independently of the shaping of the underbody panel.

In accordance with a further preferred embodiment of the invention, there is provision for the apparatus to have a location unit for the spatial location of the primary coil. This makes it possible to precisely position the secondary coil relative to the primary coil and thus prevents losses during the energy transmission. It is conceivable that the primary coil is located and a signal is provided to a driver indicating where they should drive based on the information from the location of the primary coil. It is also conceivable that the driver of the vehicle steers roughly in the direction of the primary coil and an autonomous driving program takes over the precise actuation of the primary coil.

There is preferably further provision for the apparatus to be able to move relative to the vehicle along the main plane of extent of said apparatus. This makes it possible, within a scope prescribed by the geometry of the vehicle, to bring the secondary coil for the energy transmission into an optimum position relative to the primary coil without the vehicle itself having to move in the process. It is conceivable that the apparatus is driven by motors for this purpose, which motors are controlled by a control device based on information from the location of the primary coil using the location unit.

Embodiments of the invention further provide methods for an electrical charge transfer to a vehicle having an apparatus as described above, wherein, in a first step, the vehicle is positioned so that a transmission path between the secondary coil and the primary coil is so small that an inductive energy transmission from the primary coil to the secondary coil is possible; in a second step, an alternating current is induced in the secondary coil using an alternating magnetic field generated by the primary coil and, in a third step, the alternating current induced in the secondary coil is led to the power unit. This makes it possible to easily charge a vehicle without complicated handling using cables and plugs. It is conceivable that the energy transmission process is controlled by actuation elements for actuating a charging apparatus outside of the vehicle. It is furthermore conceivable that identification elements for identifying a vehicle identify the vehicle during the energy transmission and it is thus possible, for example, to control authorizations to use the primary coil or to account for transmitted energy.

In accordance with a further preferred embodiment of the invention, there is provision for during the first step, the location unit locates the primary coil and the vehicle is positioned on the basis of the location so that a leakage flux in the inductive energy transmission is minimized. This could occur by virtue of the correct position being indicated to the driver and said driver then driving to the indicated position. However, it is also conceivable that the driver drives the vehicle roughly in the direction of the primary coil and an autonomous driving program positions the vehicle so that the primary coil and the secondary coil are placed optimally with respect to one another.

In a further preferred embodiment of the present invention, there is provision for during the first step, the location unit locates the primary coil and the vehicle is positioned on the basis of the location so that a leakage flux in the inductive energy transmission is reduced and, between the first step and the second step, the apparatus is positioned relative to the vehicle on the basis of the location so that a leakage flux in the inductive energy transmission is minimized. This advantageously makes it possible to place the secondary coil optimally on the primary coil without having to take care that the vehicle itself is in an optimum position. The precise adjustment of the secondary coil relative to the primary coil is carried out by a movement of the apparatus relative to the vehicle. It is conceivable that the apparatus is driven by motors for this purpose, which motors are controlled by a control device based on information from the location of the primary coil using the location unit.

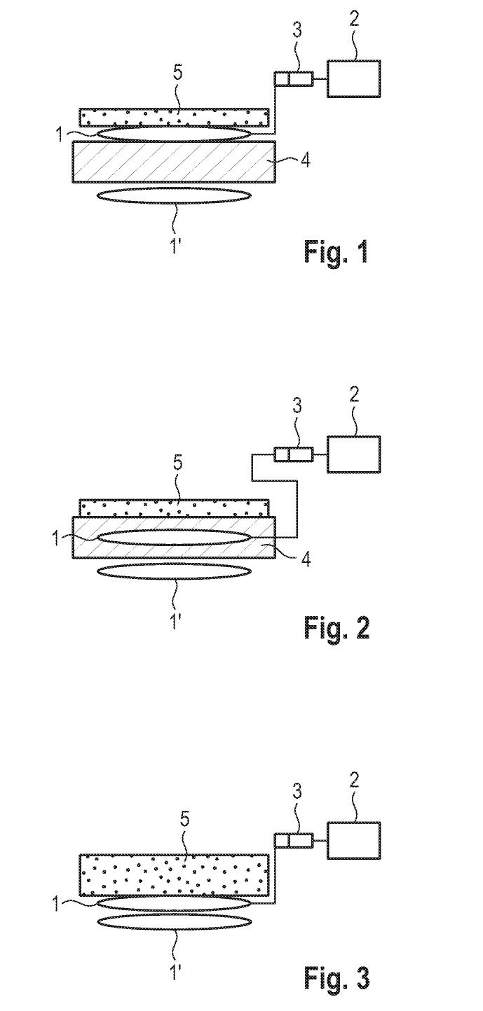

FIG. 1 shows a schematic sectional image of an apparatus according to a preferred embodiment of the invention. The primary coil 1′ is situated underneath the underbody panel 4. The secondary coil 1 is adhesively bonded to the side of the underbody panel 4 that faces away from the ground. The secondary coil is thus protected against mechanical influences due to stone chipping, for example. The secondary coil 1 is shielded against interferences by a ferrite layer. The secondary coil 1 is electrically connected to the power unit 2 of the vehicle by means of the reversibly connectable connection 3. An alternating current in the primary coil 1′ generates an alternating magnetic field, which induces an alternating current in the secondary coil 1. The vehicle is charged using said induced alternating current by means of the connection 3.

FIG. 2 shows a schematic sectional image of an apparatus according to a further preferred embodiment of the invention. The primary coil 1′ is situated underneath the underbody panel 4. The secondary coil 1 is installed in the underbody panel 4. The secondary coil is thus protected against mechanical influences due to stone chipping, for example, but the distance from the primary coil 1′ to the secondary coil 1 is reduced in comparison with the corresponding distance in the embodiment shown in FIG. 1. The ferrite layer 5, which shields the secondary coil 1 against interferences, is above the underbody panel 4. The secondary coil 1 is connected to the power unit 2 of the vehicle by means of the reversibly connectable connection 3 in the form of a clip and a corresponding mating piece. An alternating current in the primary coil 1′ generates an alternating magnetic field, which induces an alternating current in the secondary coil 1. The vehicle is charged using said induced alternating current by means of the connection 3. The secondary coil 1 is clipped to the vehicle together with the underbody panel 4 and can be removed from the vehicle reversibly as a component.

FIG. 3 shows a schematic sectional image of an apparatus according to a further preferred embodiment of the invention. The primary coil 1′ is situated underneath the underbody panel 4. The secondary coil 1 is situated between the primary coil 1′ and the underbody panel 4. The secondary coil 1 is pressed onto the underbody panel 4. The underbody panel 4 is produced from a ferrite/plastic mixture. The secondary coil 1 is connected to the power unit 2 of the vehicle by means of the reversibly connectable connection 3 in the form of a plug and a corresponding socket. An alternating current in the primary coil 1′ generates an alternating magnetic field, which induces an alternating current in the secondary coil 1. The vehicle is charged using said induced alternating current by means of the connection 3.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An apparatus for installation in a vehicle for the inductive electrical charging or discharging of the vehicle by a primary coil, the apparatus comprising:
an underbody panel; and
a secondary coil,
wherein the secondary coil is electrically connected to a power unit of the vehicle by a reversibly connectable electrical connection.

2. The apparatus as claimed in claim 1, further comprising a ferrite layer on at least a portion of a top side of the underbody panel, the top side facing away from ground in a state in which the apparatus is installed in the vehicle.

3. The apparatus as claimed in claim 1, wherein the secondary coil is mounted on a top side of the underbody panel.

4. The apparatus as claimed in claim 1, wherein the secondary coil is mounted in the underbody panel.

5. The apparatus as claimed in claim 1, wherein at least a portion of the underbody panel is produced from a ferrite/plastic mixture.

6. The apparatus as claimed in claim 5, wherein the secondary coil is mounted on the underbody panel on a bottom side of the underbody panel, wherein the bottom side of the underbody panel faces toward ground in a state in which the apparatus is installed in the vehicle.

7. The apparatus as claimed in claim 3, wherein the underbody panel and the secondary coil are configured to be reversibly screwed off, unclipped, and/or unplugged from the vehicle and/or the secondary coil is configured to be reversibly screwed off, unclipped, and/or unplugged from the vehicle and the underbody panel.

8. The apparatus as claimed in claim 3, wherein the secondary coil is adhesively bonded to the underbody panel or pressed onto the underbody panel.

9. The apparatus as claimed in claim 1, wherein the apparatus has a location unit for the spatial location of the primary coil.

10. The apparatus as claimed in claim 9, wherein the apparatus is configured to move relative to the vehicle along a main plane of extent of the apparatus.

11. A method for an electrical charge transfer to a vehicle having an apparatus for the inductive electrical charging or discharging of the vehicle by a primary coil, the method comprising:
in a first step, positioning the vehicle so that a transmission path between a secondary coil of the apparatus and the primary coil is sufficiently small to enable an inductive energy transmission from the primary coil to the secondary coil;
in a second step, inducing an alternating current in the secondary coil using an alternating magnetic field generated by the primary coil; and
in a third step, leading the alternating current induced in the secondary coil to a power unit of the vehicle,
wherein the apparatus includes an underbody panel, and
wherein the secondary coil is electrically connected to the power unit of the vehicle by a reversibly connectable electrical connection.

12. The method as claimed in claim 11, wherein the apparatus has a location unit for the spatial location of the primary coil, and
wherein, during the first step, the location unit locates the primary coil and the vehicle is positioned based on the location so that a leakage flux in inductive energy transmission falls below a threshold.

13. The method as claimed in claim 11, wherein the apparatus is configured to move relative to the vehicle along a main plane of extent of the apparatus, and
wherein, during the first step, the location unit locates the primary coil and the vehicle is positioned based on the location so that a leakage flux in the inductive energy transmission falls below a first threshold, and,
wherein between the first step and the second step, the apparatus is positioned relative to the vehicle based on the location so that a leakage flux in the inductive energy transmission falls below a second threshold.

14. The method as claimed in claim 5, wherein the secondary coil is adhesively bonded to the underbody panel or pressed onto the underbody panel.
